(19) United States
(12) Patent Application Publication
(10) Pub. No.: US 2026/0286253 A1
(43) Pub. Date: Sep. 24, 2026

(54) Dishwashing Detergent Composition

(71) Applicant: Reckitt Benckiser Finish B.V., Hoofddorp (NL)

(72) Inventors: Alias Younis Al-Bayati, Heidelberg (DE); Marco Haag, Heidelberg (DE); Torsten Roth, Heidelberg (DE); Itahisa Suarez, Heidelberg (DE); Divya Varadharajan, Heidelberg (DE)

(73) Assignee: Reckitt Benckiser Finish B.V., Hoofddorp (NL)

(21) Appl. No.: 19/473,842

(22) PCT Filed: Apr. 10, 2024
(86) PCT No.: PCT/EP2024/059684

§ 371 Date: Oct. 9, 2025

(30) Foreign Application Priority Data
Apr. 14, 2023 (GB) 2305517.1

(51) Int. Cl. C11D 3/37; C11D 3/36; C11D 17/04

(52) U.S. Cl. CPC C11D 3/3707; C11D 3/361; C11D 3/378; C11D 3/3788; C11D 17/045

(57) ABSTRACT

A dishwashing detergent composition including a non-polymeric phosphorus containing compound, a copolymeric compound having at least one monomeric unit of an acrylate, a poly(epoxysuccinic acid) or derivative thereof, and a maltodextrin grafted with a polycarboxylic acid or derivative thereof is provided. The detergent composition is substantially free of poly(aspartic acid) and derivatives thereof.

A dishwashing water-soluble container including a thermoformed water-soluble film comprising poly(vinyl alcohol) that is at least partially filled with the dishwashing detergent composition is also provided. The detergent composition may be a solid detergent composition.

### CROSS-REFERENCE TO RELATED APPLICATIONS

This application is a 371 National Stage entry of PCT/EP2024/059684, filed on Apr. 10, 2024, which claims the benefit of foreign priority to GB 2305517.1, filed on Apr. 14, 2023, in the United Kingdom, the contents of which are incorporated by reference herein in their entirety.

### FIELD OF THE INVENTION

The present invention relates to a dishwashing, preferably an automatic dishwashing, detergent composition.

The invention further relates to a dishwashing, preferably an automatic dishwashing, water-soluble container.

### BACKGROUND OF THE INVENTION

Non-polymeric phosphorus containing compounds such as phosphonates, and copolymeric compounds having at least one monomeric unit of an acrylate such as polyacrylates have been widely used in dishwashing, preferably automatic dishwashing, detergent compositions in the last decades.

However, these traditional compounds are regarded as non-readily biodegradable and non-sustainable. In these days, the importance of biodegradability and sustainability of dishwashing detergent compositions is highly increasing due to environmental aspects.

Therefore, other approaches have been attempted by using dishwashing detergent compositions lacking any non-polymeric phosphorus containing compounds such as phosphonates.

However, non-satisfying bad shine performances have been achieved for such dishwashing detergent compositions.

### OBJECTIVE OF THE PRESENT INVENTION

In view of the prior art, it was thus an object of the present invention to provide a dishwashing, preferably an automatic dishwashing, detergent composition, which shall not exhibit the aforementioned shortcomings of the known prior art dishwashing detergent compositions.

In particular, it was an object of the present invention to provide a dishwashing detergent composition, which shall ensure a shine performance being at least comparable to the commonly used dishwashing detergent compositions comprising high amounts of these phosphonates and polyacrylates; while at the same time these inventive dishwashing detergent compositions comprise much lower amounts of these non-biodegradable and non-sustainable compounds.

Hence, it was an additional object of the present invention to provide an inventive dishwashing detergent composition comprising new biodegradable and sustainable compounds, in particular polymeric compounds, which are offering a promising approach to reduce the amount of non-biodegradable and non-sustainable compounds in dishwashing detergent compositions.

### SUMMARY OF THE INVENTION

These objects and also further objects which are not stated explicitly but are immediately derivable or discernible from the connections discussed herein by way of introduction are achieved by a dishwashing, preferably an automatic dishwashing, detergent composition having all features of claim 1. Appropriate modifications to the inventive dishwashing, preferably an automatic dishwashing, detergent composition are protected in dependent claims 2 to 12. Claim 13 relates to a dishwashing, preferably an automatic dishwashing, water-soluble container. Claims 14 and 15 are appropriate modifications of such a container.

The present invention accordingly provides a dishwashing, preferably an automatic dishwashing, detergent composition, wherein the detergent composition comprises at least a non-polymeric phosphorus containing compound, at least a copolymeric compound having at least one monomeric unit of an acrylate, at least a poly(epoxysuccinic acid) or a derivative thereof, and at least a maltodextrin grafted with a polycarboxylic acid or a derivative thereof; wherein the detergent composition is substantially free, preferably completely free, of poly(aspartic acid) or a derivative thereof.

It is thus possible in an unforeseeable manner to provide a dishwashing, preferably an automatic dishwashing, detergent composition, which does not exhibit the aforementioned shortcomings of the known prior art dishwashing detergent compositions.

In particular, the dishwashing detergent composition of the present invention ensures a shine performance being at least comparable to the commonly used dishwashing detergent compositions comprising high amounts of these phosphonates and polyacrylates; while at the same time these inventive dishwashing detergent compositions comprise much lower amounts of these non-biodegradable and non-sustainable compounds.

Hence, the inventive dishwashing detergent composition of the present invention comprises two new biodegradable and sustainable compounds, in particular polymeric compounds, which are offering a promising approach to reduce the amount of non-biodegradable and non-sustainable compounds in dishwashing detergent compositions.

### Brief Description of the Tables

Objects, features, and advantages of the present invention will also become apparent upon reading the following description in conjunction with the tables, in which:

Table 1 exhibits the comparative and inventive example basis formulation.

Table 2 exhibits long term shine performance tests for comparative and inventive formulations.

Table 3 exhibits long term shine performance tests for comparative and inventive formulations.

Table 4 exhibits long term shine performance tests for comparative and inventive formulations.

Table 5 exhibits short term shine performance tests for comparative and inventive formulations.

Table 6 exhibits long term shine performance tests for comparative and inventive formulations.

### DETAILED DESCRIPTION OF THE INVENTION

The expression “substantially free” means in the context of the present invention a concentration of less than 0.25 wt %, preferably less than 0.2 wt %, and more preferably less than 0.1 wt %.

The expression “derivative” means in the context of the present invention that the defined acid group has been reacted with a respective reaction partner, such as an alcohol, an amine or another acid, to a respective ester, amide or anhydride. The expression “derivative” means also in the context of the present invention a transformation of the free acid to the respective acid salt.

The expression “poly(aspartic acid)” means in the context of the present invention poly L-aspartic acid, poly D-aspartic acid, and poly-(α,β)-DL-aspartic acid.

The expression “at least a” means in the context of the present invention “one or more than one”.

In one embodiment, the phosphorus containing compound is a non-nitrogenous bisphosphonate, preferably etidronic acid (HEDP).

In one embodiment, the detergent composition is substantially free, preferably completely free, of any homopolymer having a monomeric unit of an acrylate.

In one embodiment, the copolymeric compound comprises solely one monomeric unit of an acrylate.

In one embodiment, the copolymeric compound further comprises at least one monomeric unit having a sulfonic acid group or a derivative thereof.

In one embodiment, the copolymeric compound comprises acrylic acid and 2-Acrylamido-2-methylpropane sulfonic acid as monomeric units; wherein preferably the copolymeric compound consists essentially of acrylic acid and 2-Acrylamido-2-methylpropane sulfonic acid as monomeric units.

Exemplary sources for such a copolymeric compound include but are not limited to products sold by DOW under the tradename Acusol™ 588.

The expression “consists essentially” means in the context of the present invention a concentration of less than 10 wt %, preferably less than 5 wt %, and more preferably less than 2 wt % of any other monomeric units being part of the respective copolymeric compound.

In the context of the present invention, it has been generally found that a number average molecular weight (measured by gel permeation chromatography [GPC]) of the copolymeric compound having at least one monomeric unit of an acrylate ranging from 6 000 to 30 000 g/mol, preferably from 8 000 to 20 000 g/mol, and more preferably from 10 000 to 15 000 g/mol is suitable.

In one embodiment, the detergent composition comprises 0.1 to 10 wt %, preferably 0.2 to 8 wt %, and more preferably 0.3 to 6 wt % of the non-polymeric phosphorus containing compound.

These weight percentage values given for said non-polymeric phosphorus containing compound mean in the context of the present invention the total weight percentage values of all non-polymeric phosphorus containing compounds of the respective dishwashing detergent composition.

In one embodiment, the detergent composition comprises 0.3 to 10 wt %, preferably 0.6 to 8 wt %, and more preferably 1.2 to 6 wt % of the copolymeric compound having at least one monomeric unit of an acrylate.

These weight percentage values given for said copolymeric compound having at least one monomeric unit of an acrylate mean in the context of the present invention the total weight percentage values of all copolymeric compounds having at least one monomeric unit of an acrylate of the respective dishwashing detergent composition.

In one embodiment, the detergent composition comprises 0.3 to 20 wt %, preferably 1 to 15 wt %, and more preferably 2.5 to 7 wt % of the poly(epoxysuccinic acid) [PESA] or a derivative thereof.

These weight percentage values given for said poly(epoxysuccinic acid) or a derivative thereof mean in the context of the present invention the total weight percentage values of all poly(epoxysuccinic acid) s or a derivative thereof of the respective dishwashing detergent composition.

In the context of the present invention, it has been generally found that a number average molecular weight (measured by gel permeation chromatography [GPC]) of the poly(epoxysuccinic acid) or a derivative thereof ranging from 200 to 3000 g/mol, preferably from 300 to 2000 g/mol, and more preferably from 400 to 1500 g/mol is suitable.

In one embodiment, the detergent composition comprises 0.7 to 15 wt %, preferably 1.5 to 10 wt %, and more preferably 2.5 to 7 wt % of the maltodextrin grafted with a polycarboxylic acid or a derivative thereof. Exemplary sources for such a maltodextrin grafted with a polycarboxylic acid or a derivative thereof include but are not limited to products sold by Nouryon under the tradename Alcoguard™ H5941.

These weight percentage values given for said maltodextrin grafted with a polycarboxylic acid or a derivative thereof mean in the context of the present invention the total weight percentage values of all maltodextrins grafted with a polycarboxylic acid or a derivative thereof of the respective dishwashing detergent composition.

In the context of the present invention, it has been generally found that a number average molecular weight (measured by gel permeation chromatography [GPC]) of the maltodextrin grafted with a polycarboxylic acid or a derivative thereof ranging from 5000 to 80 000 g/mol, preferably from 8000 to 50 000 g/mol, and more preferably from 10 000 to 30 000 g/mol is suitable.

In one embodiment, the detergent composition comprises the non-polymeric phosphorus containing compound and the poly(epoxysuccinic acid) or a derivative thereof in a weight % ratio of 2:1 to 1:20, preferably of 1.5:1 to 1:16, and more preferably of 1:1 to 1:12.

In one embodiment, the detergent composition comprises the poly(epoxysuccinic acid) or a derivative thereof, and the maltodextrin grafted with a polycarboxylic acid or a derivative thereof in a weight % ratio of 5:1 to 1:3, preferably of 3.5:1 to 1:2, and more preferably of 2.1:1 to 1:1.6.

In one embodiment, the detergent composition comprises the non-polymeric phosphorus containing compound and the copolymeric compound having at least one monomeric unit of an acrylate in a weight % ratio of 1:0.5 to 1:20, preferably of 1:0.7 to 1:15, and more preferably of 1:0.8 to 1:10.

In one embodiment, the detergent composition comprises the non-polymeric phosphorus containing compound and the maltodextrin grafted with a polycarboxylic acid or a derivative thereof in a weight % ratio of 5:1 to 1:30, preferably of 3:1 to 1:25, and more preferably of 2:1 to 1:20.

Further, the object of the present invention is also solved by a dishwashing, preferably an automatic dishwashing, water-soluble container wherein said water-soluble container is made of a thermoformed water-soluble film comprising poly(vinyl alcohol) and wherein said water-soluble container is at least partially filled with such an inventive dishwashing, preferably an automatic dishwashing, detergent composition; wherein said detergent composition is preferably a solid detergent composition.

The expression “solid detergent composition” means in the context of the present invention preferably a dishwashing detergent composition in form of a powder. In cases, wherein said detergent composition of the present invention is not a solid detergent composition, it is provided in form of a liquid or a gel.

In a preferred embodiment thereof, said water-soluble container comprises at least a first compartment and at least a second compartment; wherein said at least first compartment is at least partially filled with such an inventive dishwashing, preferably an automatic dishwashing, detergent composition, wherein said detergent composition is preferably a solid detergent composition.

In an even more preferred embodiment thereof, said water-soluble container further comprises at least a third compartment; wherein said at least second compartment is at least partially filled with a liquid dishwashing, preferably a liquid automatic dishwashing, detergent composition, and wherein said at least third compartment is at least partially filled with a solid dishwashing, preferably a solid automatic dishwashing, detergent composition or with a dishwashing, preferably an automatic dishwashing, detergent composition in form of a gel.

In case that the first compartment and the third compartment are both at least partially filled with a solid detergent composition, it is not necessarily the same solid detergent composition. They can be identical or different from each other in the context of the present invention as long as the solid detergent composition, which is at least partially filled in the first compartment is representing a solid detergent composition according to the present invention.

The present invention thus addresses the problem of providing a dishwashing, preferably an automatic dishwashing, detergent composition, which ensures a shine performance being at least comparable to the commonly used dishwashing detergent compositions comprising high amounts of phosphonates and polyacrylates; while at the same time these inventive dishwashing detergent compositions comprise much lower amounts of these non-biodegradable and non-sustainable compounds.

The following non-limiting examples are provided to illustrate an embodiment of the present invention and to facilitate understanding of the invention but are not intended to limit the scope of the invention, which is defined by the claims appended hereto.

### Experimental Part

For all shine performance tests, the following method has been applied:
Machine:
   Short Term: Bosch SMS46MW03E/41
   Long Term: Miele GSL
Program:
   Short Term: Eco
   Long Term: 65° C./10 min
Evaluation by two trained assessors:
   Short Term: after 5 washing cycles
   Long Term: after 20 washing cycles
Water hardness: 21° GH
Soil load: 16 g ballast soil
Scoring for Spotting/Filming:
   5—extremely strong (worst performance)
   4—very strong
   3—strong
   2—slightly
   1—no (best performance)

Table 1 shows in the following a basis formulation used for all inventive and comparative examples of the present invention. Herein, certain basic components are listed up with their weight percentage values of the overall dishwashing detergent composition.

TABLE 1

| Comparative and inventive | |
|---|---|
| example basis formulation. | |
| | Inventive and |
| | comparative |
| | formulations |
| Trisodium Citrate | 17.0 |
| HEDP | |
| Sulfonated acrylic | Tables |
| copolymer | 2-6 |
| (Acusol TM 588) | |
| PESA | |
| Alcoguard TM | |
| H5941 | |
| Soda | 20.5 |
| Sodium | 13.8 |
| percarbonate | |
| Enzymes | 3.1 |
| Others | 5.8 |
| Surfactants | 17.9 |

Tables 2 to 6 show different series of inventive and comparative examples of the present invention having different concentrations of HEDP, Acusol™ 588, PESA, and Alcoguard™ H5941 based on the basis formulation of Table 1.

TABLE 2
Long term shine performance tests for comparative and inventive formulations

| | | | Acusol | Alcoguard | | Shine | |
|---|---|---|---|---|---|---|---|
| | HEDP | PESA | TM 588 | TM H5941 | MGDA | score | Stainless |
| | (mg) | (mg) | (mg) | (mg) | (mg) | Glass | steel |
| Formulation | (wt %) | (wt %) | (wt %) | (wt %) | (wt %) | Spotting | Filming |
| 4-BM | 976 | 129 | 711 | — | — | 2.0 | 4.6 |
| | 6.9 | 0.9 | 5.0 | | | 2.0 | 3.0 |
| 4a | 800 | 800 | 0 | 0 | 800 | 2.0 | 5.0 |
| | 5.7 | 5.7 | | | 5.7 | 2.0 | 5.0 |
| 4b | 0 | 0 | 800 | 800 | 800 | 2.0 | 4.8 |
| | | | 5.7 | 5.7 | 5.7 | 2.0 | 4.0 |
| 4c* | 400 | 400 | 400 | 400 | 800 | 2.0 | 4.3 |
| | 2.8 | 2.8 | 2.8 | 2.8 | 5.7 | 2.0 | 2.0 |
| 4d | 800 | 400 | 0 | 800 | 1600 | 2.0 | 5.0 |
| | 5.7 | 2.8 | | 5.7 | 11.4 | 2.0 | 5.0 |
| 4e* | 400 | 800 | 800 | 800 | 1600 | 2.3 | 4.1 |
| | 2.8 | 5.7 | 5.7 | 5.7 | 11.4 | 2.0 | 2.0 |
| 4f | 400 | 0 | 400 | 800 | 1600 | 2.0 | 4.6 |
| | 2.8 | | 2.8 | 5.7 | 11.4 | 2.0 | 3.0 |
| 4g | 400 | 800 | 400 | 0 | 1600 | 2.0 | 4.0 |
| | 2.8 | 5.7 | 2.8 | | 11.4 | 2.0 | 3.5 |
| 4h* | 800 | 800 | 800 | 400 | 0 | 2.0 | 4.0 |
| | 5.68 | 5.7 | 5.7 | 2.8 | | 2.0 | 2.0 |
| 4i | 0 | 800 | 400 | 0 | 1600 | 2.0 | 4.8 |
| | | 5.7 | 2.8 | | 11.4 | 2.0 | 3.5 |
| 4j | 800 | 0 | 800 | 0 | 1600 | 2.3 | 5.0 |
| | 5.7 | | 5.7 | | 11.4 | 2.0 | 3.0 |
| 4k* | 400 | 400 | 400 | 400 | 1600 | 2.0 | 4.8 |
| | 2.8 | 2.8 | 2.8 | 2.8 | 11.4 | 2.0 | 3.0 |
| 4l | 400 | 800 | 400 | 0 | 800 | 2.0 | 5.0 |
| | 2.8 | 5.7 | 2.8 | | 5.7 | 2.0 | 3.0 |

*inventive examples.

TABLE 3
Long term shine performance tests for comparative and inventive formulations

| | | | Acusol | Alcoguard | | Shine | |
|---|---|---|---|---|---|---|---|
| | HEDP | PESA | TM 588 | TM H5941 | MGDA | score | Stainless |
| | (mg) | (mg) | (mg) | (mg) | (mg) | Glass | steel |
| Formulation | (wt %) | (wt %) | (wt %) | (wt %) | (wt %) | Spotting | Filming |
| 5-BM | 976 | 129 | 711 | — | — | 2.0 | 4.6 |
| | 6.9 | 0.9 | 5.0 | | | 2.0 | 4.0 |
| 5a | 0 | 416 | 430 | 676 | 658 | 2.0 | 4.8 |
| | | 3.0 | 3.1 | 4.8 | 4.7 | 2.0 | 4.0 |
| 5b | 0 | 888 | 538 | 754 | 0 | 2.0 | 4.8 |
| | | 6.3 | 3.8 | 5.4 | | 2.0 | 4.0 |
| 5c* | 200 | 384 | 314 | 488 | 794 | 2.0 | 5.0 |
| | 1.4 | 2.7 | 2.2 | 3.5 | 5.6 | 2.0 | 3.0 |
| 5d* | 200 | 800 | 477 | 703 | 0 | 2.1 | 4.0 |
| | 1.4 | 5.7 | 3.2 | 5.0 | | 2.0 | 2.5 |

*inventive examples.

TABLE 4
Long term shine performance tests for comparative and inventive formulations

| | | | Acusol | Alcoguard | Shine | |
|---|---|---|---|---|---|---|
| | HEDP | PESA | TM 588 | TM H5941 | Score | Stainless |
| | (mg) | (mg) | (mg) | (mg) | Glass | steel |
| Formulation | (wt %) | (wt %) | (wt %) | (wt %) | Spotting | Filming |
| 6-BM | 976 | 129 | 711 | — | 2.0 | 4.6 |
| | 6.9 | 0.9 | 5.0 | | 2.0 | 3.5 |
| 6a* | 200 | 847 | 287 | 847 | 2.0 | 4.0 |
| | 1.4 | 6.0 | 2.0 | 6.0 | 2.0 | 3.0 |
| 6b* | 200 | 687 | 447 | 847 | 2.0 | 4.0 |
| | 1.4 | 4.9 | 3.2 | 6.0 | 2.0 | 3.0 |
| 6c* | 200 | 900 | 180 | 900 | 2.0 | 3.4 |
| | 1.4 | 6.4 | 1.3 | 6.4 | 2.0 | 3.0 |
| 6d* | 200 | 847 | 447 | 687 | 2.0 | 4.0 |
| | 1.4 | 6.0 | 3.2 | 4.9 | 2.0 | 3.0 |
| 6e* | 200 | 580 | 500 | 900 | 2.0 | 3.3 |
| | 1.4 | 4.1 | 3.6 | 6.4 | 2.0 | 2.5 |
| 6f* | 200 | 900 | 500 | 580 | 2.0 | 3.8 |
| | 1.4 | 6.4 | 3.2 | 4.1 | 2.0 | 2.0 |
| 6g* | 200 | 793 | 393 | 793 | 2.0 | 3.4 |
| | 1.4 | 5.6 | 2.8 | 5.6 | 2.0 | 3.0 |
| 6h* | 200 | 800 | 477 | 703 | 2.0 | 4.0 |
| | 1.4 | 5.7 | 3.2 | 5.0 | 2.0 | 2.5 |

*inventive examples.

TABLE 5
Short term shine performance tests for comparative and inventive formulations

| | | | Acusol | Alcoguard | Shine | |
|---|---|---|---|---|---|---|
| | HEDP | PESA | TM 588 | TM H5941 | Score | Stainless |
| | (mg) | (mg) | (mg) | (mg) | Glass | steel |
| Formulation | (wt %) | (wt %) | (wt %) | (wt %) | Spotting | Filming |
| 7a | — | 150 | 500 | 450 | 2.0 | 3.4 |
| | | 1.06 | 3.5 | 3.2 | 2.0 | 3.0 |
| 7b | 200 | — | 1000 | 900 | 2.8 | 3.4 |
| | 1.4 | | 7.1 | 6.4 | 2.0 | 3.0 |
| 7c | 500 | 200 | — | 900 | 2.0 | 4.0 |
| | 3.5 | 1.4 | | 6.4 | 2.0 | 3.8 |
| 7d | 200 | — | — | 900 | 2.0 | 4.0 |
| | 1.4 | | | 6.4 | 2.0 | 3.3 |
| 7e | — | 100 | — | 150 | 3.1 | 5.0 |
| | | 0.7 | | 1.06 | 3.0 | 4.0 |
| 7f | — | — | 500 | 900 | 2.0 | 4.0 |
| | | | 3.5 | 6.4 | 2.0 | 3.0 |
| 7h* | 50 | 580 | 500 | 900 | 2.0 | 3.3 |
| | 0.35 | 4.1 | 3.5 | 6.4 | 2.0 | 3.0 |
| 7i* | 500 | 580 | 500 | 900 | 2.0 | 3.9 |
| | 3.5 | 4.1 | 3.5 | 6.4 | 2.0 | 3.0 |
| 7k* | 200 | 580 | 500 | 900 | 2.0 | 3.8 |
| | 1.4 | 4.1 | 3.5 | 6.4 | 2.0 | 3.0 |

*inventive examples.

TABLE 6
Long term shine performance tests for comparative and inventive formulations

| | | | Acusol | Alcoguard | Shine | |
|---|---|---|---|---|---|---|
| | HEDP | PESA | TM 588 | TM H5941 | Score | Stainless |
| | (mg) | (mg) | (mg) | (mg) | Glass | steel |
| Formulation | (wt %) | (wt %) | (wt %) | (wt %) | Spotting | Filming |
| 7a | — | 150 | 500 | 450 | 2.0 | 4.0 |
| | | 1.06 | 3.5 | 3.2 | 2.0 | 3.0 |
| 7b | 200 | — | 1000 | 900 | 2.0 | 4.9 |
| | 1.4 | | 7.1 | 6.4 | 2.0 | 4.0 |
| 7c | 500 | 200 | — | 900 | 2.0 | 5.0 |
| | 3.5 | 1.4 | | 6.4 | 2.0 | 5.0 |
| 7d | 200 | — | — | 900 | 2.0 | 4.0 |
| | 1.4 | | | 6.4 | 2.0 | 3.4 |
| 7e | — | 100 | — | 150 | 2.0 | 5.0 |
| | | 0.7 | | 1.06 | 2.0 | 5.0 |
| 7f | — | — | 500 | 900 | 2.0 | 4.5 |
| | | | 3.5 | 6.4 | 2.0 | 3.5 |
| 7h* | 50 | 580 | 500 | 900 | 2.0 | 4.0 |
| | 0.35 | 4.1 | 3.5 | 6.4 | 2.0 | 3.0 |
| 7i* | 500 | 580 | 500 | 900 | 2.0 | 4.0 |
| | 3.5 | 4.1 | 3.5 | 6.4 | 2.0 | 3.0 |
| 7k* | 200 | 580 | 500 | 900 | 2.0 | 4.0 |
| | 1.4 | 4.1 | 3.5 | 6.4 | 2.0 | 2.0 |

*inventive examples.

While the principles of the invention have been explained in relation to certain particular embodiments, and are provided for purposes of illustration, it is to be understood that various modifications thereof will become apparent to those skilled in the art upon reading the specification. Therefore, it is to be understood that the invention disclosed herein is intended to cover such modifications as fall within the scope of the appended claims. The scope of the invention is limited only by the scope of the appended claims.

1. A dishwashing detergent composition, comprising:
at least a non-polymeric phosphorus containing compound,
at least a copolymeric compound having at least one monomeric unit of an acrylate,
at least a poly(epoxysuccinic acid) or a derivative thereof, and
at least a maltodextrin grafted with a polycarboxylic acid or a derivative thereof;
wherein the detergent composition is substantially free of poly(aspartic acid) and derivatives thereof.

2. The dishwashing detergent composition according to claim 1, wherein the phosphorus containing compound is a non-nitrogenous bisphosphonate.

3. The dishwashing detergent composition according to according to claim 1, wherein the copolymeric compound includes only one monomeric unit of an acrylate.

4. The dishwashing detergent composition according to claim 1, wherein the copolymeric compound includes acrylic acid and 2-acrylamido-2-methylpropane sulfonic acid as monomeric units.

5. The dishwashing detergent composition according to claim 1, wherein the detergent composition includes from 0.1 to 10 wt % of the non-polymeric phosphorus containing compound.

6. The dishwashing detergent composition according to claim 1, wherein the detergent composition includes from 0.3 to 10 wt % of the copolymeric compound having at least one monomeric unit of an acrylate.

7. The dishwashing detergent composition according to claim 1, wherein the detergent composition includes from 0.3 to 20 wt % of the poly(epoxysuccinic acid) or a derivative thereof.

8. The dishwashing detergent composition according to claim 1, wherein the detergent composition includes from 0.7 to 15 wt % of the maltodextrin grafted with the polycarboxylic acid or a derivative thereof.

9. The dishwashing detergent composition according to claim 1, wherein the detergent composition includes the non-polymeric phosphorus containing compound and the poly(epoxysuccinic acid) or derivative thereof in a weight % ratio of from 2:1 to 1:20.

10. The dishwashing detergent composition according to claim 1, wherein the detergent composition includes the poly(epoxysuccinic acid) or a derivative thereof, and the maltodextrin grafted with the polycarboxylic acid or a derivative thereof in a weight % ratio of from 5:1 to 1:3.

11. The dishwashing detergent composition according to claim 1, wherein the detergent composition includes the non-polymeric phosphorus containing compound and the copolymeric compound having at least one monomeric unit of an acrylate in a weight % ratio of from 1:0.5 to 1:20.

12. The dishwashing detergent composition according to claim 1, wherein the detergent composition includes the non-polymeric phosphorus containing compound and the maltodextrin grafted with the polycarboxylic acid or derivative thereof in a weight % ratio of from 5:1 to 1:30.

13. A dishwashing water-soluble container, comprising:
a thermoformed water-soluble film including poly(vinyl alcohol), wherein the water-soluble container is at least partially filled with the dishwashing detergent composition according to claim 1.

14. The dishwashing water-soluble container according to claim 13, wherein the water-soluble container includes:
at least one first compartment, and
at least one second compartment,
wherein the at least one first compartment is at least partially filled with a dishwashing detergent composition according to claim 1.

15. The dishwashing water-soluble container according to claim 14, wherein the water-soluble container further includes at least a one third compartment; wherein the at least one second compartment is at least partially filled with a liquid dishwashing detergent composition, and wherein the at least one third compartment is at least partially filled with a solid dishwashing detergent composition or with a dishwashing detergent composition in form of a gel.

16. The dishwashing detergent composition according to claim 1, wherein the dishwashing detergent composition is an automatic dishwashing detergent composition.

17. The dishwashing detergent composition according to claim 1, wherein the non-polymeric phosphorus containing compound is etidronic acid.

18. The dishwashing detergent composition according to claim 1, wherein the detergent composition is substantially free of any homopolymer having a monomeric unit of an acrylate.

19. The dishwashing detergent composition according to claim 1, wherein the copolymeric compound further comprises at least one monomeric unit having a sulfonic acid group or a derivative thereof.

20. The dishwashing detergent composition according to claim 1, wherein the copolymeric compound consists essentially of acrylic acid and 2-acrylamido-2-methylpropane sulfonic acid as monomeric units.
